(19) United States
(12) Patent Application Publication
(10) Pub. No.: US 2002/0099603 A1
(43) Pub. Date: Jul. 25, 2002

(54) Communication network with temporary display network for outdoor signs III

(76) Inventor: Clarence H. Bandura, Los Angeles, CA (US)

Correspondence Address: Clarence H. Bandura, P.O. Box 811691, Los Angeles, CA, 90017, US

(21) Appl. No.: 09/767,015

(22) Filed: Jan. 22, 2001

Related U.S. Application Data
(60) Provisional application No. 60/268,748, filed on Feb. 13, 2001.

(51) Int. Cl. G06F 17/60

(52) U.S. Cl. 705/14

(57) ABSTRACT

A permanent communication network system consisting of a central computer for sending and receiving data via hard wiring is used to display messages on outdoor signs. A unique and flexible application known as a temporary display network provides a search feature to analyze availability of signs and demographic data for the purchase of timed display intervals at preselected locations and/or regions. The selected locations of display exhibit rotating, syncronized, or repeating message displays on minute by minute or longer prescribed intervals.

### SUMMARY

The combination of a permanent and temporary network display utilizing timed display intervals gives flexability for interchanging or syncronizing customized outdoor display data.

### RELATED APPLICATIONS

Communication Network for Outdoor Signs (application Dec. 20, 2000) and Communication Network for Outdoor Signs II (application Jan. 02, 2001)

Inventor: Clarence H. Bandura

### BACKGROUND OF INVENTION

Communication networking for outdoor signs was a limited application due to an infrastructure that was undeveloped.

### DETAILED DESCRIPTION OF THE PREFERRED EMBODIMENT

Outdoor signs are networked for the purposes of electronic message display with hard-wiring i.e. cable, telephone lines, or fiber optics and connected to a central computer of which is described herein as paragraph (1) with recognition as “The Permanent Network”.

An advertiser or user uploads a desired message to the computer via; computer(s) or physically by verbal or written instruction and/or copy to the central computer operator who thereby inputs same.

Computer(s) connected to the permanent network utilize a search feature accessed with passwords or logging onto the central computer. This search feature offers advertising data and constitutes a temporary network deemed herein as “The Temporary Display Network” as paragraph (3). This customized demographic data is preselected and designed to suit the requirements of the advertiser or user through programmed information consisting of specified time intervals of display being one time, syncronized, repeating or rotating throughout selected locations and regions. Other pertinent advertising preselected data includes traffic counts of sign locations and the type of surrounding business environment i.e. financial, retail, industrial, sports etc.

I claim:

1) Electronic communication and networking of data for electronic display on outdoor signs through hard wiring i.e. cable, telephone lines, fiber optics, or other wiring connections.

2) Electronic communication and data exchange as claimed in claim 1 through a central computer system comprised of a single computer being connected to the outdoor signs via hard wiring as described in claim 1.
The combination of claim 1 and 2 is deemed herein and known as “The permanent display network”.

3) A prescribed data display message known as and deemed herein as “The temporary display network”. is compiled by the intended advertiser or user via a single computer being a stand alone computer or public kiosk computer.
a search feature included with the temporary display network provides demographic data and availablity of outdoor sign locations described as: business categories i.e. industrial, financial, retail, sports etc. and being displayed locally,or internationally with preselected time intervals for display per location and time of day. Traffic counts and peak message display times also comprise search data.
timed intervals, preselected, are programmed to be one time, syncronized, repeating, or rotating for display throughout selected locations and/or regions.

4) The temporary display network in claim 3 is compiled by the intended advertiser or user and then uploaded directly by the central computer operator as in claim 2 Instructions with the desired message are provided by the intended advertiser to the central computer operator verbally or in written form.

5) Reservations of preselected time display intervals as in claim 3 with payment arrangement with participating outdoor sign locations and related administrations.

6) Bidding for outdoor sign locations and specific display time intervals in claim 3 having bids priced by related sign administrations.
bidding for timed intervals of display either present or future reservations.
bidding arranged with the central computer operator via computer in claim 3 or directly as in claim 4.
